(19) United States
(12) Patent Application Publication
(10) Pub. No.: US 2026/0138698 A1
(43) Pub. Date: May 21, 2026

(54) VEHICLE COMPRISING A CANOPY AND A TRAY

(71) Applicant: Bruno Masci, Celebration, FL (US)

(72) Inventor: Bruno Masci, Celebration, FL (US)

(21) Appl. No.: 19/372,162

(22) Filed: Oct. 28, 2025

Related U.S. Application Data
(60) Provisional application No. 63/720,983, filed on Nov. 15, 2024.

(51) Int. Cl. B62J 17/086; B62J 1/28; B62J 7/02

(52) U.S. Cl. CPC B62J 17/086; B62J 1/28; B62J 7/02; B62K 2202/00

(57) ABSTRACT

A vehicle having a canopy assembly and a tray assembly including a canopy frame having a telescopic frame. The canopy frame includes a L-shaped slider frame, a center rod, connecting rods, hinge connectors, and U-shaped frames enabling folding and deployment of the canopy assembly. The canopy assembly removably connects to the vehicle and offers protection from sun, rain and weather conditions. The tray assembly includes a frame mount and tray plates. The frame mount includes frames positioned in a U-shaped manner, and retractable frames connected to the frames. The tray plates hingedly connect to the retractable frames. The tray assembly includes cover plates and a mount cover. The tray plates fold and retractable frames position over the frames such that the tray plates position adjacent to the frames in a stowed configuration. The cover plates and the mount cover conceal the frames, the retractable frames and the tray plates.

### CROSS-REFERENCE TO RELATED APPLICATIONS

The present application claims benefit of U.S. Provisional Application No. 63/720,983, filed Nov. 15, 2024; which is incorporated herein in its entirety and referenced thereto.

### BACKGROUND OF THE INVENTION

### Field of the Invention

The present subject matter relates to the field of vehicle accessories, and in particular, relates to a canopy assembly and a tray assembly designed for a vehicle such as a scooter, for example.

### Description of the Prior Art

It is known that vehicles such as scooters, bicycles, motorcycles, etc., are used for personal transportation. At times, riders are exposed to environments such as sunlight and rain. Typically, the riders rely on umbrellas and raincoats to protect themselves from the sunlight or rain. However, they are inconvenient to use during travel. In order to overcome the above problems, canopies have been attached to the vehicles for providing shade from the sun and protection from rain.

An example of canopy is disclosed in a U.S. Pat. No. 8,479,756, entitled “Canopy assembly” (“the '756 Patent”). The '756 Patent discloses a canopy assembly provided for shading a person while riding a bicycle. The assembly includes a pair of spaced side members and a pair of spaced end members. The end members are coupled to and extend between the side members defining an open frame. A cover is coupled to the frame. A connecting bar has an upper end and a lower end. The upper end of the connecting bar is coupled to the frame. A clamp is coupled to the lower end of the connecting bar frictionally engaging a bicycle whereby the frame is coupled to the bicycle.

Another example is disclosed in a U.S. Pat. No. 7,585,020, entitled “Sunshade apparatus” (“the '020 Patent”). The '020 Patent discloses a sunshade apparatus for shading a chair has a flexible canopy element, and a support structure for supporting the flexible canopy element above the chair. A pair of attachment elements is attached to the bottom ends of a pair of vertical support legs of the support structure. Each of the attachment elements includes a pair of clamp elements that each include a clamping end opposite a lever end, the clamping ends of the pair of clamp elements together being shaped to engage the chair. A hinge connects the clamp elements, and a spring biases them towards a closed position.

Another example is disclosed in a U.S. Pat. No. 11,001,326, entitled “Canopy apparatus and bicycle formed therewith” (“the '326 Patent”). The '326 Patent discloses a canopy apparatus that includes a support assembly extending from an attached bracket configured to be fixed to a bicycle to an attached canopy extending outwardly from the support assembly over the bracket for providing shade or shelter from the Sun and weather conditions, and a caution flag, or increasing the visibility of the canopy apparatus, depending downwardly from the canopy to an intermediate position of the support assembly between the bracket and the canopy. The support assembly includes a plurality of segments releasably secured with lock pins and compression couplings.

Although the above discussed disclosures are useful, they still have problems and present incomplete solutions. For instance, many canopies are either cumbersome or do not shield the riders adequately from adverse weather conditions. Additionally, the canopies are poorly designed and as a result provide inadequate coverage and become unstable at higher speeds.

Further, the scooters have limited space for carrying items and performing tasks while on the go. In order to overcome the problem, the scooters have been provided with a fixed tray. The fixed tray may hinder the rider's experience. As such, it is desirable to provide a foldable/retractable tray.

Several foldable/retractable tray designs have been disclosed in the past. One such example is disclosed in a U.S. Pat. No. 11,299,276, entitled “Seat system with stowable tray” (“the '276 Patent”). The '276 Patent discloses a seat system for a passenger aircraft. The seat system includes at least one passenger seat and a stowable tray installed onto or adjacent to the passenger seat. The stowable tray includes a tray plate adapted to support one or more items; a support arm attached to the tray plate adapted to move the tray plate between a stowable position and a presentation position; and a friction hinge attaching the tray plate to the support arm and adapted to adjust the tray plate between the presentation position and a tray position, wherein the tray plate is adapted to support a personal electronic device while in the presentation position and adapted to support one or more cocktail items while in the tray position. A second stowable tray may also be attached to the passenger seat.

Another example is disclosed in a U.S. Publication No. 2024239491, entitled “Passenger seat tray table” (“the '491 Publication”). The '491 Publication discloses a passenger seat assembly for an aircraft having a seat; and an armrest. The armrest comprises a tray table movable between a stowed configuration and a deployed configuration. The position of the tray table is adjustable, relative to the seat, in the depth wise direction and in a height wise direction when in the deployed configuration.

Yet another example is disclosed in a U.S. Pat. No. 8,474,384, entitled “Folding armrest tray for wheelchairs” (“the '384 Patent”). The '384 Patent discloses a tray assembly mounted on a wheelchair. A housing containing the tray is mounted along the side of the chair arm. The tray assembly has a tray surface moveable between a stowed and unstowed position.

Although the above discussed disclosures are useful, they still have problems and present incomplete solutions. For instance, many of the tray designs are provided for fixed chairs. The trays provided at the armrest of the wheelchair can only be used for simple tasks such as placing food, lightweight items, etc., as they lack strength and stability.

Therefore, there is a need in the art to provide a vehicle/scooter having a canopy for offering protection from the environment, and a foldable tray that can be adjusted between a working position and a stowed position.

### SUMMARY OF THE INVENTION

It is an object of the present subject matter to provide a foldable canopy assembly for personal transport vehicles that can be easily deployed and retracted.

It is another object of the present subject matter to provide a canopy assembly that removably connects to the vehicle.

It is another object of the present subject matter to provide a tray assembly that can be easily deployed or stowed/stored.

It is another object of the present subject matter to provide a tray assembly having a frame mount assembly that can conceal the tray in stowed/stored configuration.

It is another object of the present subject matter to provide a tray assembly that allows to slidably adjust the position of the tray in deployed configuration.

In one aspect, the present subject matter provides a vehicle having a canopy assembly. The canopy assembly removably connects to the vehicle. The canopy assembly includes a canopy frame. The canopy frame includes a telescopic frame that helps to adjust the height of the canopy assembly. The canopy frame includes connecting rods. The telescopic frame connects to a connecting rod of the connecting rods. The connecting rods connect to a center rod. Further, the connecting rods connect to extending bars which in turn connect to hinge connectors. The hinge connectors connect to U-shaped frames. The canopy frame includes a canopy connected via loops.

Further, the canopy frame includes a L-shaped slider frame that allows the center rod to be folded with respect to the telescopic frame. The hinge connectors and the L-shaped slider frame enable the canopy assembly to be folded when not in use. The canopy assembly may remain connected to the vehicle in folded configuration when not in use.

In another aspect, the present subject matter provides a vehicle having a tray assembly. The tray assembly includes a frame mount assembly. The frame mount assembly includes a frame mount. The frame mount includes frames (first frame, second frame and third frame) positioned in a U-shaped manner. The frame mount includes extendable/retractable frames (fifth frame and sixth frame) that connect to the frames. The extendable/retractable frames receive a hingedly connected tray. The tray is made up of tray plates connected by a central connecting plate. The connecting plate connects to the extendable/retractable frames.

Further, the frame mount assembly includes cover plates and a mount cover. The cover plates and the frames present a gap at the sides of the frames. The tray plates fold and extendable/retractable frames position over the frames such that the tray plates sit in the gap formed between the cover plates and the frames, and the tray is concealed within the frame mount assembly in a stowed/stored configuration.

The tray assembly can be folded easily and can be adjusted to two positions i.e., a working position for placing objects while on the go, and/or a storage/stowed position. When not in use, the tray folds up and is stored in the vehicle's armrest, allowing it to be easily pulled out when needed.

These and other objects of the present subject matter will be apparent from review of the following specification and the accompanying drawings.

### BRIEF DESCRIPTION OF THE DRAWINGS

FIG. 1 is an environment of a vehicle having a canopy assembly, and being operated by a user, in accordance with one embodiment of the present subject matter.

FIG. 2 is a bottom perspective view of the vehicle having the canopy assembly, in accordance with one embodiment of the present subject matter.

FIG. 3 is a side perspective view of the vehicle having the canopy assembly, in which a telescopic frame is retracted, in accordance with one embodiment of the present subject matter.

FIG. 4 is an exploded view of the canopy assembly, in accordance with one embodiment of the present subject matter.

FIG. 5 and FIG. 7 show enlarged views of the canopy assembly, in accordance with one embodiment of the present subject matter.

FIG. 6 is an enlarged view of a hinge connector of the canopy assembly, in accordance with one embodiment of the present subject matter.

FIG. 8A, FIG. 8B, FIG. 8C, FIG. 8D and FIG. 8E show foldable feature of the canopy frame, in accordance with one embodiment of the present subject matter.

FIG. 9A and FIG. 9B show a front perspective view and a rear perspective view, respectively, of a vehicle having a tray assembly, in accordance with one embodiment of the present subject matter.

FIG. 10A and FIG. 10B show a left-side perspective view and a right-side perspective view, respectively of the tray assembly, in accordance with one embodiment of the present subject matter.

FIG. 11 is an exploded view of the tray assembly, in accordance with one embodiment of the present subject matter.

FIG. 12 is a partial view of the tray assembly, in accordance with one embodiment of the present subject matter.

FIG. 13 and FIG. 14 show enlarged views (top and bottom views) of tray plates, in accordance with one embodiment of the present subject matter.

FIG. 15 shows the feature of a fifth frame connecting to a connecting frame, in accordance with one embodiment of the present subject matter.

FIG. 16 shows the feature of a sixth frame extending from the fifth frame, in accordance with one embodiment of the present subject matter.

FIG. 17 shows a tray plate comprising ribs, in accordance with one embodiment of the present subject matter.

FIG. 18 shows the angle of the ribs, in accordance with one embodiment of the present subject matter.

FIG. 19, FIG. 20, and FIG. 21 show operational features of the tray assembly, in accordance with one embodiment of the present subject matter.

### DETAILED DESCRIPTION OF THE PREFERRED EMBODIMENT

The detailed description set forth below in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed vehicle having a canopy assembly and a tray assembly. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed vehicle having a canopy assembly and a tray assembly.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present subject matter encompasses present and future known equivalents to the known components referred to herein by way of illustration.

Although the present subject matter describes the vehicle having a canopy assembly and a tray assembly, it is to be further understood that numerous changes may arise in the details of the embodiments of the vehicle having a canopy assembly and a tray assembly. It is contemplated that all such changes and additional embodiments are within the spirit and true scope of this subject matter.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the subject matter and are not intended to limit the scope of the subject matter.

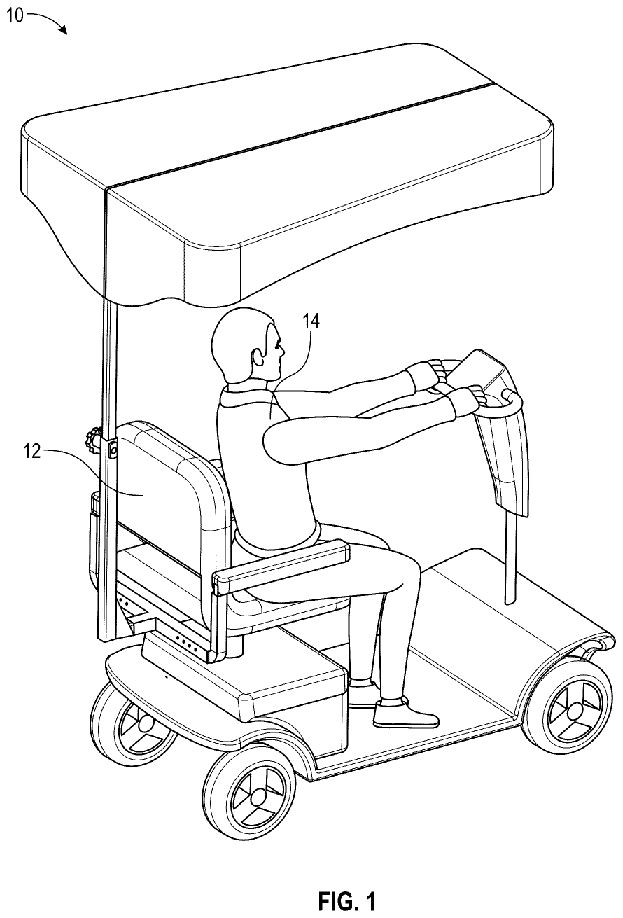

Various features and embodiments of the vehicle comprising a canopy and a tray are explained in conjunction with the description of FIGS. 1-21.

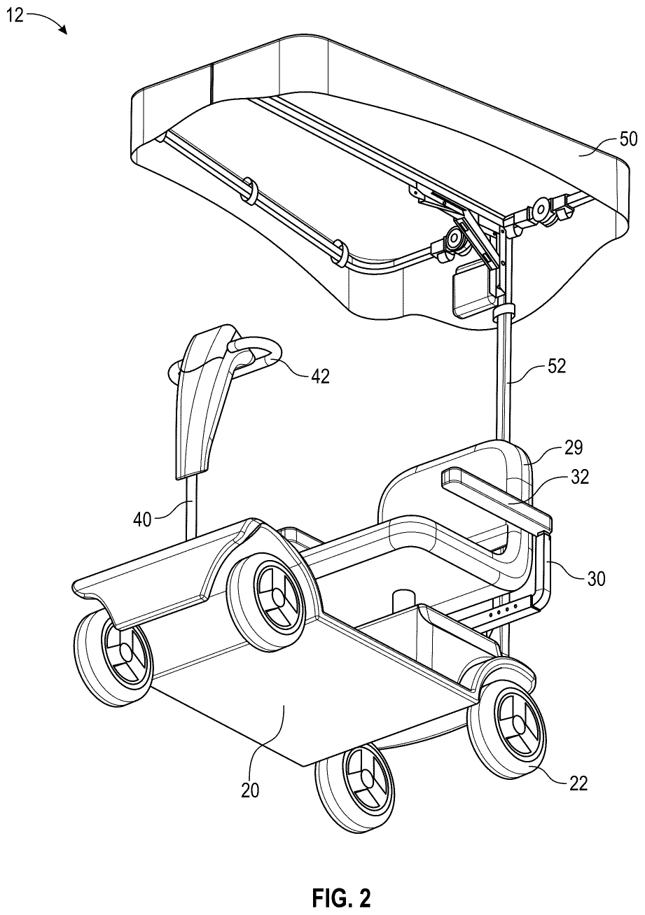

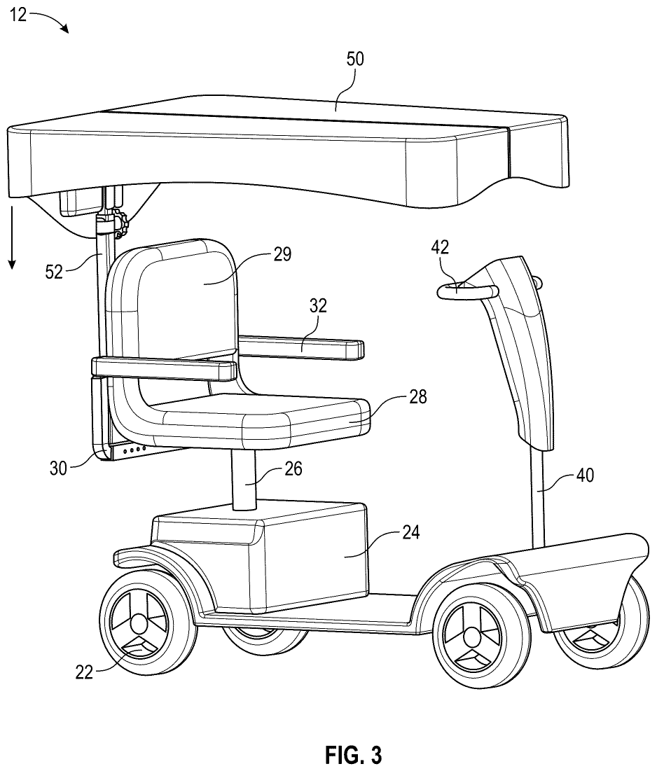

FIG. 1 shows an environment 10 of a vehicle 12, while being operated by a user 14, in accordance with one exemplary embodiment of the present subject matter. Here, vehicle 12 includes a scooter, bicycle, tricycle and other vehicles used for personal transportation or goods transportation depending on the need. FIG. 2 shows a bottom side perspective of vehicle 12 having a canopy assembly 50, in accordance with one embodiment of the present subject matter. FIG. 3 shows a side perspective view of vehicle 12. A person skilled in the art understands that FIG. 2 shows canopy assembly 50 in extended configuration and FIG. 3 shows canopy assembly 50 in lowered configuration (telescopic frame 53).

Vehicle 12 includes a base 20. Base 20 is made of metal, hard plastic or any other suitable material. Base 20 encompasses wheels 22 underneath for maneuvering vehicle 12. Base 20 includes a housing 24 positioned at opposite side of wheels 22. In one example, housing 24 indicates a container or box for storing a battery (not shown) and other electronic components (not shown) required for operating vehicle 12. In one embodiment, vehicle 12 presents an extending rod 26. Extending rod 26 extends from housing 24 and receives a seat 28 with a backrest 29. In one example, extending rod 26 connects to a seating frame 30. In another example, seating frame 30 connects to seat 28. Further, seating frame 30 includes an armrest 32. Armrest 32 allows user 14 to user to rest his/her arms.

As can be seen, vehicle 12 encompasses a steering rod 40 positioned at the opposite of seat 28. Steering rod 40 extends from base 20 and includes a handle 22 for steering vehicle 12. In one example, handle 22 includes control buttons (not shown) for operating vehicle 12.

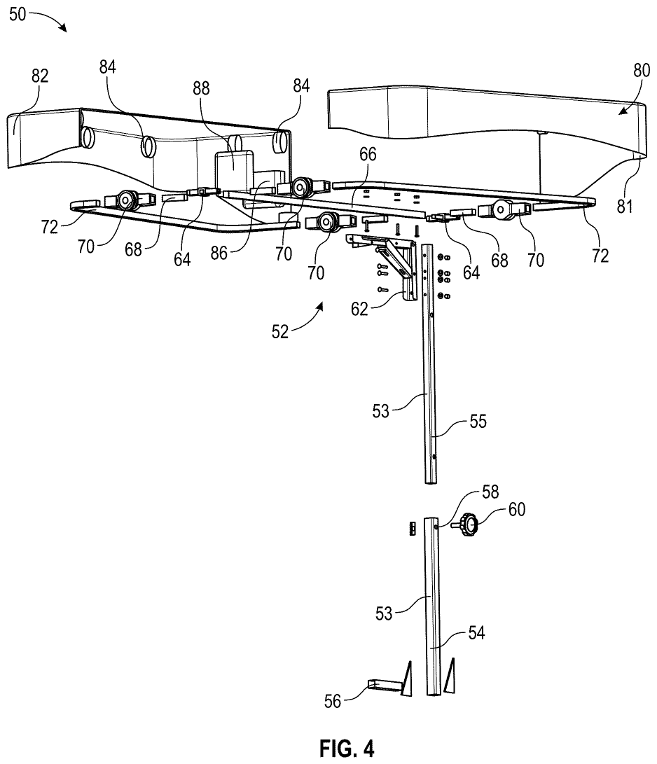

As specified above, vehicle 12 includes a canopy assembly 50. Referring to FIG. 4, an exploded view of canopy assembly 50 is shown, in accordance with one embodiment of the present subject matter. Canopy assembly 50 encompasses a canopy frame 52. Canopy frame 52 includes a telescope frame 53. Telescope frame 53 encompasses a first rod 54 and a second rod 55. First rod 54 has a slightly larger diameter than second rod 55. In one example, first rod 54 includes one or more holes 58. A handle lever 60 is inserted into one of holes 58 to adjust the height of telescope frame 53. FIG. 2 shows telescope frame 53 in which second rod 55 extends from first rod 54. FIG. 3 shows telescope frame 53 in which second rod 55 is retracted into first rod 54 thereby reducing the height of telescope frame 53. In one embodiment, first rod 54 includes a frame connecting rod 56 at the bottom. Frame connecting rod 56 helps to connect first rod 54 of telescope frame 53 to seating frame 30.

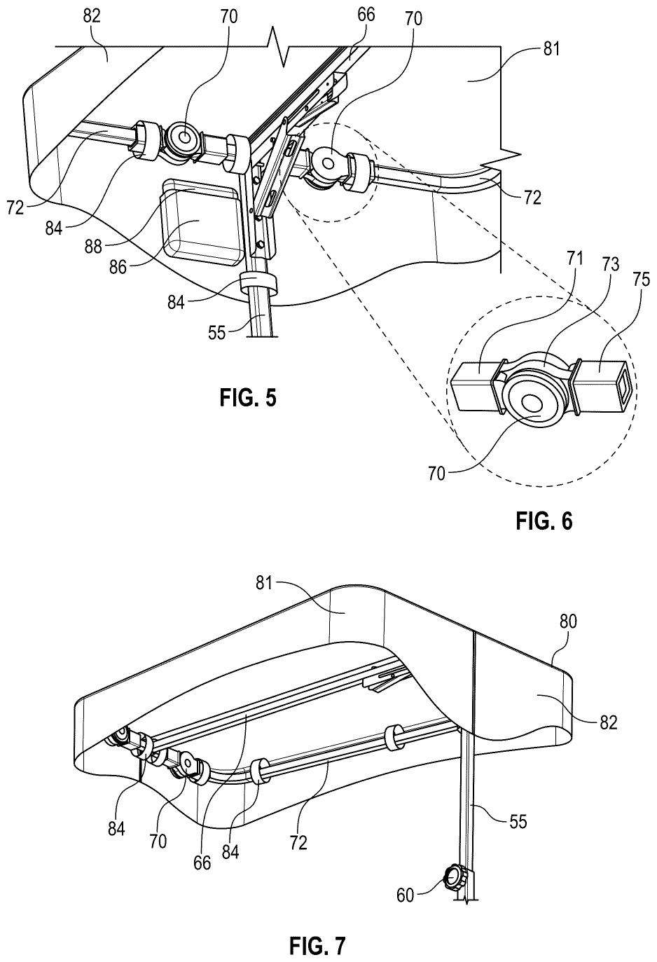

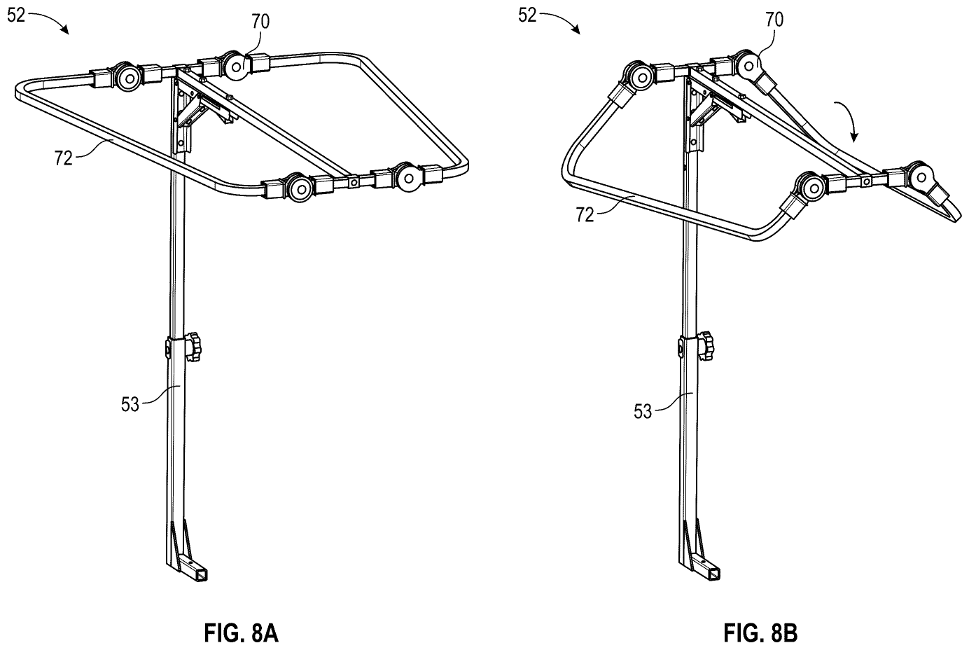

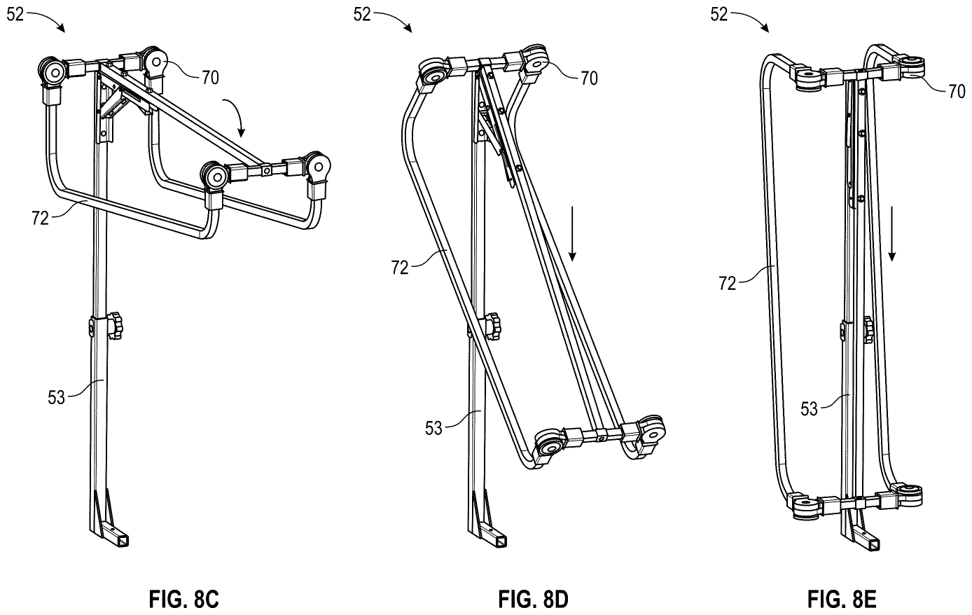

At the top, second rod 55 includes a L-shaped slider frame 62. Here, second rod 55 connects to a connecting rod 64 of a pair of connecting rods 64. Further, connecting rods 64 receive a center rod 66 that extends perpendicularly from second rod 55. L-shaped slider frame 62 acts as a support mechanism intersecting second rod 55 and center rod 66, as can be seen from FIG. 5. Each connecting rod 64 connects to an extending bar 68. Further, each extending bar 68 connects to a hinge connector 70. FIG. 6 shows an enlarged view of hinge connector 70, in accordance with one embodiment of the present subject matter. Hinge connector 70 includes an extending bar receiver 71 and a rod receiver 75 connected via a hinge member 73. In other words, hinge member 73 positions between extending bar receiver 71 and rod receiver 75. Here, extending bar receiver 71 receives one end of extending bar 68 and opposing rod receivers 75 receive ends of U-shaped frame 72. Hinge member 73 configures to operate such that rod receiver 75 can be positioned between 90 and 180 degrees with respect to extending bar receiver 71. The 90-degree position corresponds to the fully deployed configuration where U-shaped frame 72 is positioned perpendicularly to telescope frame 53, providing maximum canopy coverage and structural stability. The 180-degree position represents the fully folded configuration where the shorter sides of U-shaped frame 72 come in parallel to telescope frame 53. This angular range allows U-shaped frame 72 to be rotated from the perpendicular deployed position at 90 degrees through intermediate positions to the parallel folded position at 180 degrees (FIG. 8A through FIG. 8C).

Further, canopy assembly 50 includes a valance or canopy 80. FIG. 5 and FIG. 7 show partial views of canopy assembly 50, in accordance with one embodiment of the present subject matter. Canopy 80 has a first canopy part 81 and a second canopy part 82 connected to each other forming a complete canopy 80. Canopy 80 attaches to canopy frame 52 via loops 84. Loops 84 are provided around connecting rod 64, U-shaped frames 72 and/or second rod 55, as can be seen from FIG. 5 and FIG. 7. In one example, canopy 80 includes one or more block housings 86. Block housings 86 configure to receive solid blocks 88 therein. Blocks 88 come in a variety of shapes, sizes and weights. Blocks 88 ensure canopy 80 stays firm and do not deflect or deform due to wind or weather conditions. Further, blocks 88 ensure that canopy 80 remains in shape/stable when vehicle 12 is travelling at higher speeds.

Now referring to FIG. 8A, FIG. 8B. FIG. 8C, FIG. 8D, and FIG. 8D, the foldability of canopy frame 52 is shown, in accordance with one embodiment of the present subject matter. At first, canopy frame 52 is positioned in an extended manner or deployed configuration (FIG. 8A) in which canopy assembly 50 is used for providing protection from sunlight, rain and environment for user 14. In order to fold, U-shaped frames 72 are rotatably pushed via hinge members 73, as shown in FIG. 8B. Upon pushing, U-shaped frames 72 fold as shown in FIG. 8C. After folding, L-shaped slider frame 62 enables folding of center rod 66 over telescope frame 53 by pushing down center rod 66 (FIG. 8D), until the longer sides of U-shaped frames 72 come substantially parallel to telescope frame 53, as shown in FIG. 8E.

In some implementations, the canopy frame 52 is made to fold while canopy 80 is connected. This allows canopy assembly 50 to fold when protection is not needed from sun, rain, etc. In order to protect user 14 from sunlight and/or rain, user 14 may deploy/extend canopy assembly 50, as shown in FIG. 2, for example. In one example, canopy 80 is made of a soft material such that it becomes easy to fold. Further, canopy 80 is made of waterproof material with suitable strength to prevent user 14 from getting wet and also to withstand the weather conditions. Optionally, canopy 80 is made of a hard or semi-hard material to ensure it retains the shape when canopy frame 52 is positioned in fold configuration (FIG. 8E) and extended configuration (FIG. 8A).

In order to deploy canopy assembly 50, user 14 lifts center rod 66 such that center rod 66 comes in perpendicularly to telescope frame 53. Subsequently, user 14 pushes up or rotates U-shaped frames 72 to position canopy frame 52 (with canopy 80) as shown in FIG. 8A, as shown in FIG. 2.

The presently disclosed canopy assembly presents several advantages over the prior art. The canopy assembly can be retracted and made to fold around the telescopic frame. This allows the canopy assembly to remain connected to the vehicle at all times. When needed, the user can extend the canopy assembly for shielding from sun, rain and harsh weather conditions. The telescopic frame allows the user to adjust the height of the canopy assembly without affecting the functionality of the canopy assembly. The canopy assembly has a unique hinge connector that allows folding the distal U-shaped frames. Further, the canopy assembly has a unique L-shaped slider frame that allows the entire top portion of the canopy frame to fold over the telescopic frame.

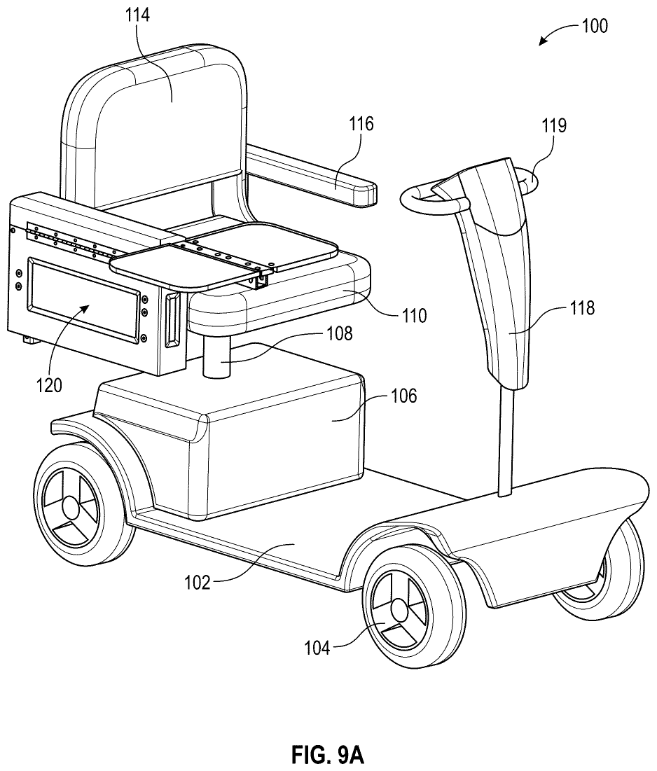

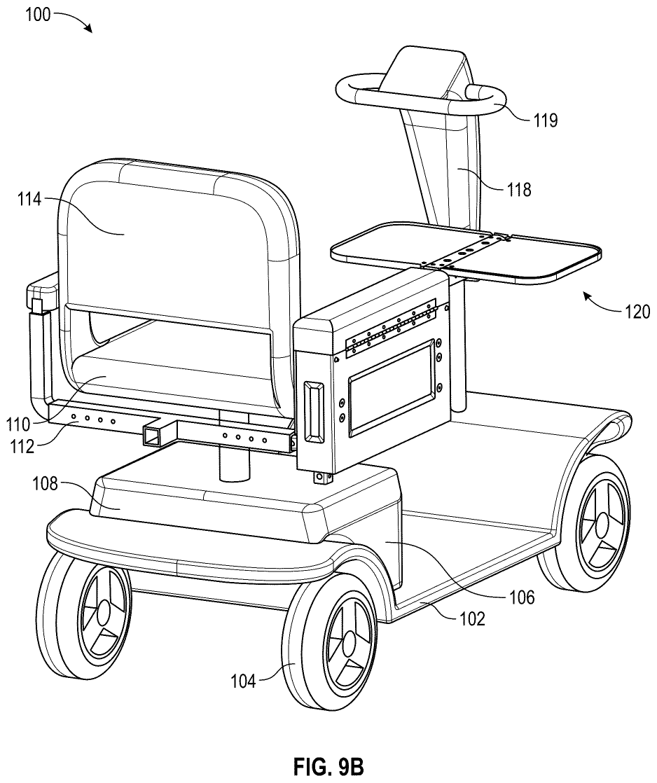

Now referring to FIG. 9A and FIG. 9B, a front perspective view and a rear perspective view, respectively, of a vehicle 100 having a tray assembly 120 is shown, in accordance with one embodiment of the present subject matter. Vehicle 100 includes a base 102. Base 102 is made of metal, hard plastic or any other suitable material. Base 102 encompasses wheels 104 underneath for maneuvering vehicle 102. Base 102 includes a housing 106 positioned at the opposite side of wheels 104. In one example, housing 106 indicates a container or box for storing a battery (not shown) and other electronic components (not shown) required for operating vehicle 100. In one embodiment, vehicle 100 presents an extending rod 108. Extending rod 108 extends from housing 106 and receives a seat 110 having a backrest 114. In one example, extending rod 108 connects to a seating frame 112. In another example, seating frame 112 connects to seat 110. Further, seating frame 112 includes an armrest 116. Further, vehicle 100 encompasses a steering rod 118 positioned at the opposite of seat 110. Steering rod 118 extends from base 102 and includes a handle 119 for steering vehicle 100. In one example, handle 119 includes control buttons (not shown) for operating vehicle 100.

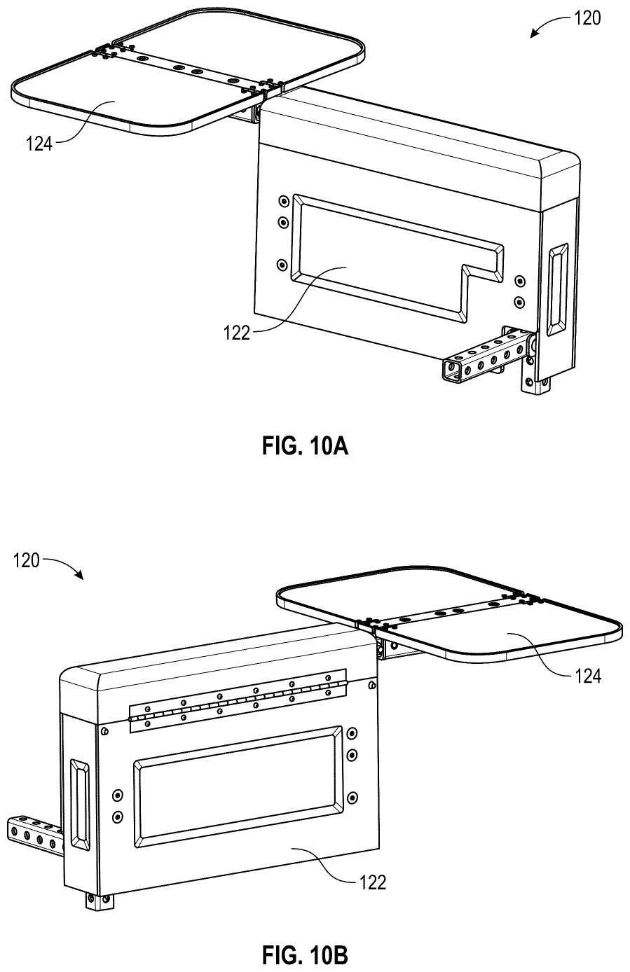

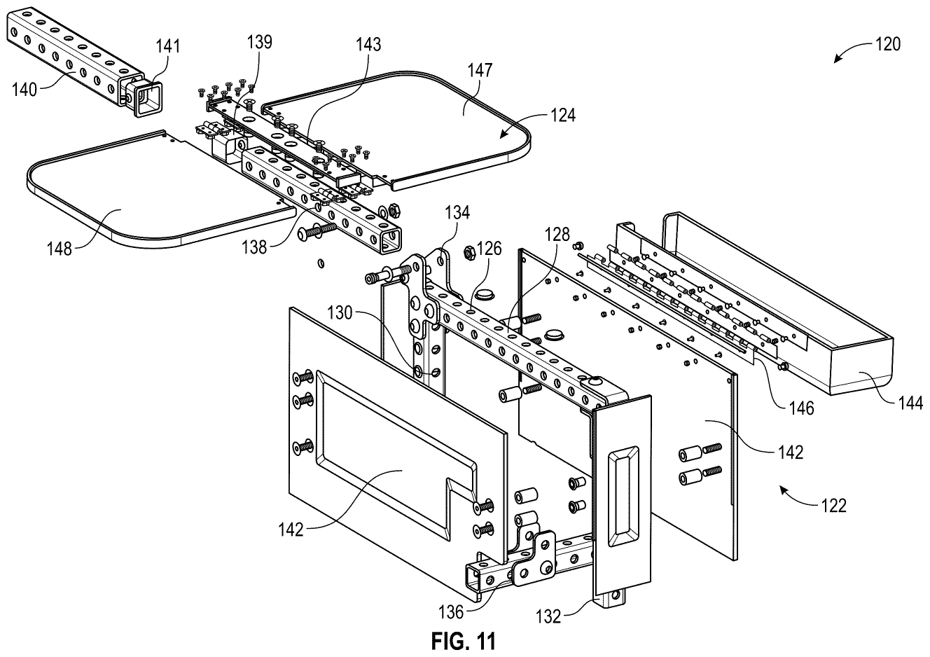

FIG. 10A and FIG. 10B show a left-side perspective view and a right-side perspective view, respectively, of tray assembly 120, in accordance with one embodiment of the present subject matter. Tray assembly 120 encompasses a frame mount assembly 122 and a tray 124. Further, FIG. 11 shows an exploded view of tray assembly 120, in accordance with one embodiment of the present subject matter. As can be seen, frame mount assembly 122 encompasses a frame mount 126. Frame mount 126 comes in a U-shaped configuration. Frame mount 126 includes a first frame/tube 128, a second frame/tube 130, and a third frame/tube 132. Second frame 130, and third frame 132 position parallel to each other and mount at opposite ends of first frame 128 in a perpendicular manner. In one example, first frame 128 and second frame 130 present a connecting frame 134. Connecting frame 134 extends upwards from the intersection of first frame 128 and second frame 130. Further, frame mount 126 includes a fourth frame 136. Fourth frame 136 extends perpendicularly from third frame 132, as can be seen from FIG. 11. It should be understood that fourth frame 136 connects to seating frame 112 and ensures first frame 128, second frame 130, and third frame 132 mount at the side of seat 110, as can be seen from FIG. 9A and FIG. 9B, for example.

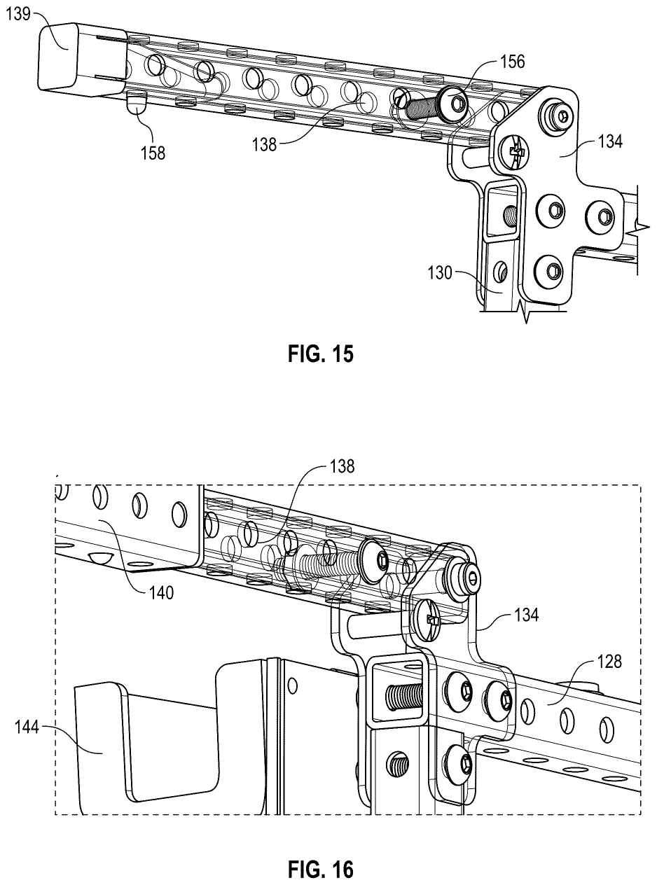

Further, frame mount 126 includes a fifth frame 138. Fifth frame 138 connects to connecting frame 134 via first fasteners 156 (FIG. 15). Further, fifth frame 138 includes a cover cap 139. Cover cap 139 connects at the distal end of fifth frame 138 and prevents users (not shown) from getting injured. FIG. 15 shows the feature of fifth frame 138 having cover cap 139 and connected to connecting frame 134.

Additionally, frame mount 126 presents a sixth frame 140. Sixth frame 140 goes over fifth frame 138. In other words, sixth frame 140 is slightly larger than fifth frame 138 such that sixth frame 140 is made to receive fifth frame 138 within while fifth frame 138 is connected to connecting frame 134 from one end. In one example, sixth frame 140 includes an end cap 141. End cap 141 is made of a soft material. End cap 141 mounts at the end where sixth frame 140 receives fifth frame 138. FIG. 16 shows the feature of fifth frame 138 positioned within sixth frame 140, and fifth frame 138 connected to connecting frame 134.

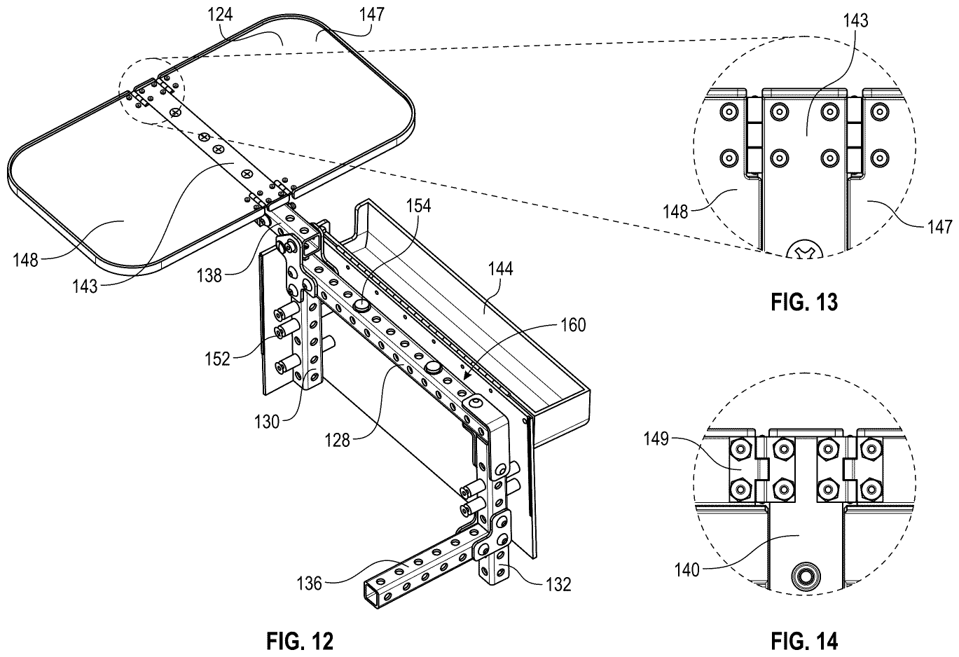

Further, frame mount assembly 122 encompasses cover plates 142 configured for covering frame mount 126. As can be seen from at least FIG. 10A, FIG. 10B and FIG. 11, cover plates 142 are positioned around to conceal frame mount 126. Further, FIG. 12 shows the feature of cover plate 142 connected to second frame 130 and third frame 132 via connectors 152. In some embodiments, first frame 128 receives press fit bumpers 154 to protect tray 124 in stowed away position.

Further, frame mount assembly 122 includes a mount cover 144 connecting to cover plates 142 via hinge members 146. Mount cover 144 conceals frame mount 126 from the top, as can be seen from FIG. 10A and FIG. 10B, for example.

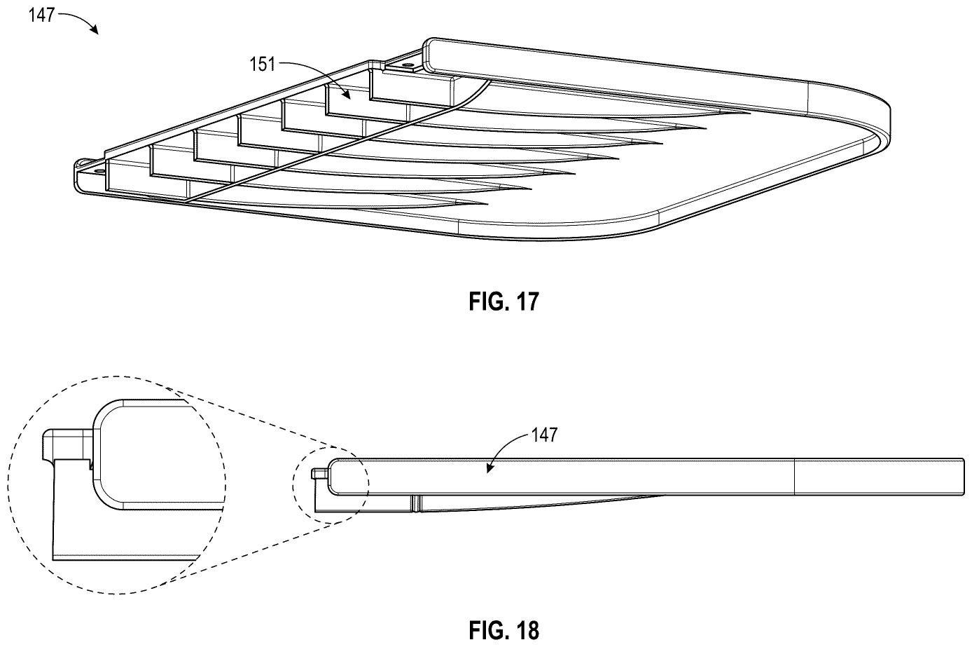

Further, tray 124 encompasses a first tray plate 147 and a second tray plate 148. Furthermore, tray 124 encompasses a tray connecting plate 143 that connects first tray plate 147 and second tray plate 148. It should be understood that tray connecting plate 143, first tray plate 147 and second tray plate 148 together form tray 124 in deployed configuration. In the present subject matter, tray connecting plate 143 connects over sixth frame 140 via pins 158, as can be seen from FIG. 12 and FIG. 15. In one example, tray connecting plate 143 connects to first tray plate 147 and second tray plate 148 via hinges 149. FIG. 13 shows an enlarged view of (showing top of) tray connecting plate 143 connecting to first tray plate 147 and second tray plate 148 with the help of hinges 149. Further, FIG. 14 shows an enlarged view of (showing sixth frame 140 seen from the bottom) tray connecting plate 143 connecting to first tray plate 147 and second tray plate 148 with the help of hinges 149. In one example, first tray plate 147 (and second tray plate 148) includes ribs 151 as shown in FIG. 17. Ribs 151 are angled at about 91 degrees to prevent sagging, as shown in FIG. 18.

In accordance with the present subject matter, cover plates 142 present a gap 160 (FIG. 12) with respect to frame mount 126. The gap 160 helps to stow tray 124 i.e., first tray plate 147 and second tray plate 148 on both sides between cover plates 142 and frame mount 126 (first frame 128, second frame 130, and third frame 132).

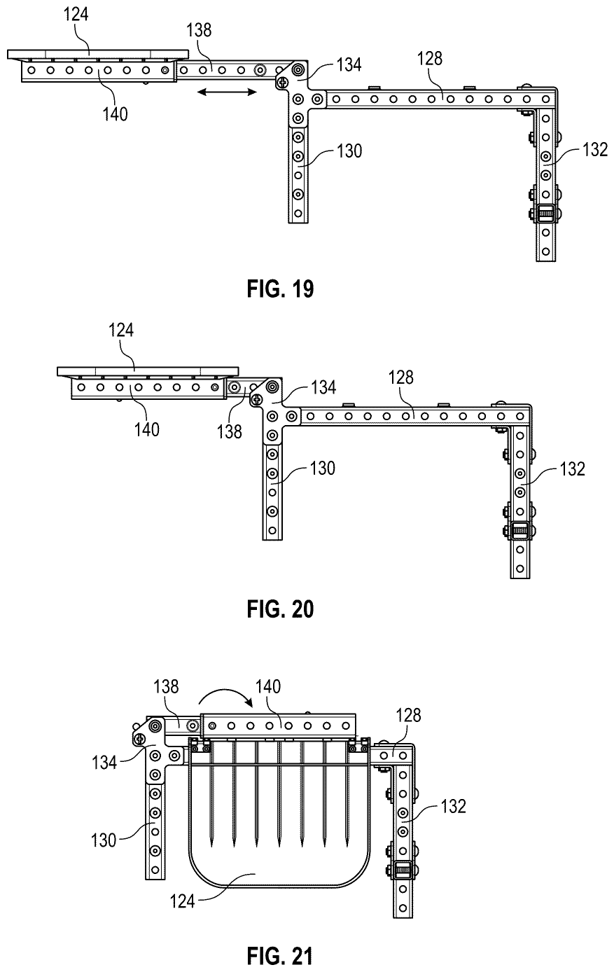

Now referring to FIG. 19 through FIG. 21, operation of tray assembly 120 is explained, in accordance with one embodiment of the present subject matter. A person skilled in the art understands that FIG. 19, FIG. 20, and FIG. 21 show side views of tray assembly 120 without cover plates 142 and mount cover 144 to illustrate the internal working of tray assembly 120. FIG. 19 shows tray 124 in deployed position (similar to FIG. 9A, for example). As can be seen, tray 124 is made to position over sixth frame 140, which extends from fifth frame 138. Here, sixth frame 140 may be operated to extend and retract over fifth frame 138 to adjust the extension of tray 124 from cover plates 142. In order to stow tray 124, sixth frame 140 is made to slide over fifth frame 138, as can be seen from FIG. 20. Subsequently, fifth frame 138 is made to rotate with respect to second frame 130 via connecting frame 134 such that fifth frame 138 sits over first frame 128, as shown in FIG. 21. Concurrently, first tray plate 147 and second tray plate 148 are made to enter in the gap 160 formed between frame mount 126 (i.e., between first frame 128, second frame 130, and third frame 132) and cover plates 142. As this point, first tray plate 147 and second tray plate 148 sit in the gap 160 at respective sides between first frame 128, second frame 130, and third frame 132; and cover plates 142 while sixth frame 140 (having fifth frame 138 and connecting tray connecting plate 143) sits over first frame 128 (FIG. 21). Subsequently, mount cover 144 is placed over cover plates 142 to conceal tray 124 and frame mount 126 entirely within cover plates 142 and mount cover 144. This way, tray 124 is stowed away inside frame mount assembly 122.

When needed, the user may remove mount cover 144 and lift sixth frame 140 and extend it from fifth frame 138 (as shown in FIG. 19 or FIG. 20). Subsequently, tray 124 may be extended (FIG. 9B, for example) for placing objects.

In some embodiments, tray assembly 120 may be connected to armrest 32 of vehicle 12 as described above in relation to the canopy assembly. The frame mount assembly 122 may be adapted to interface with armrest 32 through suitable modifications to fourth frame 136 or through additional mounting brackets that connect to seating frame 30. In such configurations, the tray assembly 120 operates independently of canopy assembly 50, allowing users to deploy and stow tray 124 without affecting the functionality of the canopy system. The independent operation is facilitated by separate control mechanisms, wherein the deployment and stowing of tray 124 through the rotation of fifth frame 138 and the sliding motion of sixth frame 140 does not interfere with the telescopic adjustment of canopy assembly 50 or the folding operations of center rod 66 and U-shaped frames 72. The mounting points for tray assembly 120 are positioned such that the mechanical linkages and pivot points of the tray system remain isolated from the canopy frame 52 and its associated components.

The modular design of the present subject matter allows for flexible configuration options. In some cases, vehicle 12 may be equipped with canopy assembly 50 alone to provide weather protection for the user. In other cases, vehicle 12 may include only tray assembly 120 to offer a convenient work surface and storage solution. In some aspects, both canopy assembly 50 and tray assembly 120 may be installed on the same vehicle 12, providing comprehensive functionality for users who require both weather protection and a deployable work surface. The independent functionality is maintained through distinct operational pathways, wherein the user can manipulate tray 124 between deployed and stowed positions without requiring any adjustment or repositioning of canopy assembly 50, and conversely, the extension, retraction, and folding operations of canopy assembly 50 can be performed without affecting the position or stability of tray assembly 120.

The independent operation of tray assembly 120 from canopy assembly 50 may be achieved through separate mounting points on seating frame 30 or armrest 32. This modular approach allows manufacturers to offer different vehicle configurations based on user preferences and intended applications. The mounting mechanisms for both assemblies may be designed to avoid interference with each other when both systems are present on the same vehicle. The independence is further ensured by providing separate structural load paths, wherein the forces generated during tray deployment and stowing are transmitted through frame mount assembly 122 directly to seating frame 30 without affecting telescopic frame 53 or the stability of canopy 80. Additionally, the clearance zones around both assemblies are configured such that the full range of motion of tray 124, including the rotation of fifth frame 138 and the extension of sixth frame 140, does not encroach upon the operational envelope of canopy assembly 50, thereby maintaining complete functional independence between the two systems.

In some embodiments, tray assembly 120 may include locking mechanisms to secure tray 124 in both deployed and stowed positions. The locking mechanisms may comprise spring-loaded pins, detent mechanisms, or friction locks that engage with corresponding receptacles or grooves in fifth frame 138 and sixth frame 140. These locking mechanisms may prevent unintended movement of tray 124 during vehicle operation and ensure stable positioning when the tray is in use.

In some aspects, tray 124 may include adjustable height features through telescopic sections in fifth frame 138 or sixth frame 140. The telescopic sections may allow users to customize the working height of tray 124 to accommodate different user preferences or task requirements. Height adjustment mechanisms may include twist locks, pin locks, or cam levers that secure the telescopic sections at desired positions.

In some cases, first tray plate 147 and second tray plate 148 may include surface treatments or coatings to enhance functionality. These treatments may comprise non-slip surfaces, scratch-resistant coatings, or easy-clean materials. The tray plates may also incorporate raised edges or lips to prevent objects from sliding off during vehicle movement.

In some embodiments, tray assembly 120 may include integrated storage compartments within first tray plate 147 or second tray plate 148. These compartments may be configured to hold small items such as pens, tools, or electronic devices. The compartments may include removable inserts or dividers to organize different types of objects.

In some aspects, frame mount assembly 122 may incorporate dampening mechanisms to control the movement of tray 124 during deployment and stowing operations. The dampening mechanisms may comprise hydraulic dampers, pneumatic cylinders, or friction dampers that provide smooth and controlled motion while preventing sudden or jarring movements.

In some cases, tray assembly 120 may include electrical connections or power outlets integrated into tray 124 or frame mount assembly 122. These electrical features may allow users to charge electronic devices or power small appliances while using the tray. The electrical connections may be routed through hollow sections of fifth frame 138 or sixth frame 140 to maintain a clean appearance.

In some aspects, tray assembly 120 may include weight distribution features to balance the load when objects are placed on tray 124. These features may comprise counterweights within frame mount assembly 122 or adjustable support legs that extend from tray 124 to provide additional stability during use.

In some cases, the connection between tray connecting plate 143 and sixth frame 140 may include rotational adjustment mechanisms that allow tray 124 to be angled or tilted relative to the horizontal plane. This angular adjustment may accommodate different user preferences or task requirements, such as reading, writing, or viewing electronic displays.

In some embodiments, frame mount assembly 122 may include modular attachment points that allow additional accessories to be connected to tray assembly 120. These accessories may comprise cup holders, device mounts, tool holders, or lighting fixtures that enhance the functionality of tray 124 for specific applications.

The presently disclosed tray assembly provides several advantages over the prior art. The tray assembly integrates into a vehicle and offers a convenient and functional tray. The tray can be easily deployed and stowed away as needed. The tray assembly presents a unique frame mount assembly that allows the frame to be folded over and have cover plates capable of receiving the tray plates within. When not in use, the cover plates and the mount cover act as protective enclosures for the frame mount assembly and the stowed tray. This ensures the tray remains clean when not in use.

The tray assembly is securely mounted to the vehicle's seating frame and remains stable during use. Further, the frame mount assembly offers a telescopic mechanism with fifth frame and the sixth frame allowing the user to customize the position of the tray when deployed.

In the above description, numerous specific details are set forth such as examples of some embodiments, specific components, devices, methods, in order to provide a thorough understanding of embodiments of the present subject matter. It will be apparent to a person of ordinary skill in the art that these specific details need not be employed, and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention/subject matter, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A vehicle comprising:
a base having wheels for maneuvering said vehicle;
a seat mounted on said base; and
a canopy assembly removably connected to said vehicle, said canopy assembly comprising:
a canopy frame having a telescopic frame;
a center rod extending from said telescopic frame;
connecting rods connecting said telescopic frame to said center rod;
extending bars connected to said connecting rods;
hinge connectors connected to said extending bars;
U-shaped frames connected to said hinge connectors;
a canopy connected to said canopy frame via loops; and
a L-shaped slider frame enabling said center rod to be folded with respect to said telescopic frame, wherein said hinge connectors and said L-shaped slider frame enable said canopy assembly to be folded when not in use.

2. The vehicle of claim 1, wherein said telescopic frame comprises a first rod and a second rod, wherein said second rod is adjustable relative to said first rod to adjust a height of said canopy assembly, wherein said first rod comprises one or more holes, and wherein said telescopic frame comprises a handle lever configured to be inserted into one of said holes to adjust said height of said telescopic frame.

3. The vehicle of claim 1, wherein said canopy includes one or more block housings configured to receive solid blocks therein to ensure said canopy stays firm and does not deflect due to wind or weather conditions.

4. The vehicle of claim 1, wherein said canopy comprises a first canopy part and a second canopy part connected to each other forming a complete canopy, and wherein said canopy is made of waterproof material configured to withstand weather conditions.

5. The vehicle of claim 1, wherein each hinge connector of said hinge connectors comprises an extending bar receiver and a rod receiver connected via a hinge member, wherein said extending bar receiver receives one end of said extending bar and said rod receiver receiving ends of said U-shaped frame.

6. The vehicle of claim 5, wherein said hinge member configures to operate such that said rod receiver is positioned between 90 and 180 degrees with respect to said extending bar receiver.

7. The vehicle of claim 1, wherein said U-shaped frames are rotatable via said hinge connectors to fold said canopy assembly.

8. The vehicle of claim 1, further comprising:
an armrest connected to said seat; and
a tray assembly connected to said seat via said armrest, said tray assembly comprising:
a frame mount assembly having a frame mount with a first frame, a second frame, and a third frame positioned in a U-shaped configuration;
a connecting frame extending upwards from an intersection of said first frame and said second frame;
a fifth frame connected to said connecting frame;
a sixth frame that receives said fifth frame within and is slidable relative to the said fifth frame;
a tray having a first tray plate, a second tray plate, and a tray connecting plate that connects said first tray plate and said second tray plate, wherein said tray connecting plate connects to said sixth frame; and
cover plates positioned around said frame mount and presenting a gap with respect to said frame mount, wherein said first tray plate and said second tray plate are configured to fold and position within said gap in a stowed configuration.

9. The vehicle of claim 8, wherein said frame mount comprises a fourth frame that extends perpendicularly from said third frame and connects to said armrest to mount said tray assembly at a side of said seat.

10. The vehicle of claim 8, wherein said tray assembly operates independently of said canopy assembly, allowing users to deploy and stow said tray without affecting functionality of said canopy assembly.

11. The vehicle of claim 8, wherein said fifth frame is rotatable with respect to said second frame via said connecting frame such that said fifth frame sits over said first frame in said stowed configuration.

12. The vehicle of claim 8, wherein said tray connecting plate connects to said first tray plate and said second tray plate via hinges.

13. The vehicle of claim 8, further comprising a mount cover connecting to said cover plates via hinge members, wherein said mount cover conceals said frame mount from the top when said tray is in said stowed configuration.

14. The vehicle of claim 1, wherein said L-shaped slider frame enables folding of said center rod over said telescopic frame by pushing down said center rod until longer sides of said U-shaped frames come substantially parallel to said telescopic frame.

15. A vehicle comprising:
a base having wheels for maneuvering said vehicle;
a seat mounted on said base;
a canopy assembly removably connected to said vehicle, said canopy assembly including:
a canopy frame having a telescopic frame;
a center rod extending from said telescopic frame;
connecting rods connecting said telescopic frame to said center rod;
extending bars connected to said connecting rods;
hinge connectors connected to said extending bars;
U-shaped frames connected to said hinge connectors;
a canopy connected to said canopy frame via loops; and
a L-shaped slider frame enabling said center rod to be folded with respect to said telescopic frame, wherein said hinge connectors and said L-shaped slider frame enable said canopy assembly to be folded when not in use;
an armrest connected to said seat; and
a tray assembly connected to said seat via said armrest, said tray assembly comprising:
a frame mount assembly having a frame mount with a first frame, a second frame, and a third frame positioned in a U-shaped configuration;
a fifth frame connected to said frame mount;
a sixth frame that receives said fifth frame within and is slidable relative to said fifth frame;
a tray having a first tray plate, a second tray plate, and a tray connecting plate that connects said first tray plate and said second tray plate, wherein said tray connecting plate connects to said sixth frame; and
cover plates positioned around said frame mount and presenting a gap with respect to said frame mount, wherein said first tray plate and said second tray plate are configured to fold and position within said gap in a stowed configuration.

16. The vehicle of claim 15, wherein each hinge connector comprises an extending bar receiver and a rod receiver connected via a hinge member, wherein said extending bar receiver receives one end of said extending bar and said rod receiver receiving ends of said U-shaped frame, and wherein said hinge member configures to operate such that said rod receiver is positioned between 90 and 180 degrees with respect to said extending bar receiver.

17. The vehicle of claim 15, wherein said tray assembly operates independently of said canopy assembly, allowing users to deploy and stow said tray without affecting functionality of said canopy assembly.

18. The vehicle of claim 15, wherein said first frame and said second frame present a connecting frame that extends upwards from an intersection of said first frame and said second frame, and wherein said fifth frame connects to said connecting frame, wherein said fifth frame is rotatable with respect to said second frame via said connecting frame such that said fifth frame sits over said first frame in said stowed configuration.

19. The vehicle of claim 15, further comprising a mount cover connecting to said cover plates via hinge members, wherein said mount cover conceals said frame mount from the top when said tray is in said stowed configuration.

20. A method of providing a canopy assembly for a vehicle, said method comprising the steps of:
providing a base having wheels for maneuvering said vehicle;
providing a seat mounted on said base;
providing a canopy assembly removably connecting to said vehicle, said canopy assembly including:
providing a canopy frame having a telescopic frame;
providing a center rod extending from said telescopic frame;
connecting said telescopic frame to said center rod via connecting rods;
connecting extending bars to said connecting rods;
connecting hinge connectors to said extending bars;
connecting U-shaped frames to said hinge connectors;
connecting a canopy to said canopy frame via loops; and
providing a L-shaped slider frame enabling said center rod to be folded with respect to said telescopic frame, wherein said hinge connectors and said L-shaped slider frame enable said canopy assembly to be folded when not in use.
